(19) United States
(12) Patent Application Publication
(10) Pub. No.: US 2025/0234082 A1
(43) Pub. Date: Jul. 17, 2025

(54) THINABLE IMAGE SENSING MODULE

(71) Applicant: Shi Wu LO, Changhua County (TW)

(72) Inventor: Shi Wu LO, Changhua County (TW)

(21) Appl. No.: 18/414,860

(22) Filed: Jan. 17, 2024

(51) Int. Cl. H04N 23/57; G03B 30/00; H04N 23/55

(52) U.S. Cl. CPC H04N 23/57; G03B 30/00; H04N 23/55

(57) ABSTRACT

A thinable image sensing module comprises at least two image sensors, at least two lens units, and at least two filter units. The at least two image sensors are separately disposed. Each image sensor has a light-incident surface. The at least two lens units are respectively disposed at the outer side of the light-incident surface of the at least two image sensors. The at least two filter units are respectively disposed between the at least two image sensors and the at least two lens units. The filtering characteristics of the at least two filter units are distinct from each other. Each image sensor senses a part of color light and needs less amount of light incidence. Therefore, a relative distance between the image sensor and the lens unit is shorter such that the invention can be thinned.

### BACKGROUND OF THE INVENTION

### 1. Field of the Invention

The invention relates to an image sensing module, particularly to a thinable image sensing module.

### 2. Description of the Related Art

For satisfying photographing and video recording demands, an image sensing module, namely a camera module, has become basic equipment of an electronic device, such as a smart phone, a tablet, and so on. Please refer to FIG. 20, a conventional image sensing module comprises an image sensor 61, a filter unit 62, and a lens unit 63. The lens unit 63 is coupled to a focus motor (not shown in the figure).

The image sensor 61 comprises a plurality of image elements 610 arranged in a matrix. Each image element 610 may be a complementary metal-oxide-semiconductor (CMOS). The filter unit 62 comprises a plurality of filter lenses arranged in a matrix. One of the filter lenses is disposed on a light-incident surface of one of the image elements 610. The lens unit 63 is substantially composed of multiple lenses. In this way, an external light penetrating the lens unit 63 and the filter unit 62 can be sensed by the image sensor 61. The focus motor is utilized to adjust a focus of the lens unit 63. For instance, the common focus motor is a voice coil motor (VCM).

For generating a color image, the filter unit 62 comprises the filter lenses of distinct colors. Therefore, the filter lenses are called a color filter array. Taking FIG. 20 as an example, the filter lenses comprise a red-light filter lens 621, a green-light filter lens 622, and a blue-light filter lens 623. A 2×2 matrix unit is composed of a red-light filter lens 621, a blue-light filter lens 623, and two green-light filter lenses 622, that is, a well-known Bayer filter. In other words, in the image sensor 61, one-quarter of the image elements 610 correspond to the red-light filter lenses 621, one-quarter of the image elements 610 correspond to the blue-light filter lenses 623, and one-half of the image elements 610 correspond to the green-light filter lenses 622. Taking the conventional image sensing module comprising twelve million image elements 610 as an example, three million image elements 610 correspond to the red-light filter lenses 621, three million image elements 610 correspond to the blue-light filter lenses 623, and six million image elements 610 correspond to the green-light filter lenses 622. A processor calculates and generates a color image according to an output signal of the image elements 610.

It is comprehensible that the more the amount of the image elements 610 and the amount of the filter lens corresponding to the image elements 610 are, the higher the resolution of the color image obtains. However, to maintain the same image quality, the image elements 610 in a larger amount are deployed across a wider area. Correspondingly, a light-incident aperture of the lens unit 63 needs to be expanded to increase a total amount of light incidence. Furthermore, a signal-to-noise ratio (SNR) can be maintained, and the resolution and the quality of the color image can be improved.

However, in the prerequisite for expanding the light-incident aperture of the lens unit 63, the focus distance of the lens unit 63 is extended and the thickness of the conventional image sensing module, that is, the lens unit 63, the image element 610 and so on, thereby increases. Hence, the conventional image sensing module fails to be widely applied to a thinned device, such as a smart phone, a tablet, a camera disposed in front of a mobile, a camera disposed in front of a notebook, a camera disposed in front of a tablet, and so on.

### SUMMARY OF THE INVENTION

In view of the above, the invention provides a thinable image sensing module to solve the problems that a whole thickness of the image sensing module increases resulting from that the conventional image sensing module improves the resolution of the color image.

The thinable image sensing module comprises at least two image sensors, at least two lens units, and at least two filter units. The at least two image sensors are disposed separately and each image sensor has a light-incident surface. The at least two lens units are respectively disposed at the outer side of the light-incident surface of the at least two image sensors. The at least two filter units are respectively disposed between the at least two image sensors and the at least two lens units. The filtering characteristics of the at least two filter units are different from each other.

According to the structure of the image sensing module in the invention, the filtering characteristics of the at least two filter units are distinct from each other. That is, each image sensor in the invention senses lights in some colors via the filter unit corresponding to the image sensor, but not the conventional image sensing module that utilizes a single image sensor to sense all color lights. Hence, the invention uses a plurality of image sensors to sense all color lights, that is, a color range that can be perceived by normal human eyes. When the at least two image sensors are electrically connected to a processor, the processor calculates and combines a color image according to the output signal of the image sensors.

When the amount of the image element in each image sensor is added, since each image sensor senses a part of color lights via the filter unit corresponding to the image sensor, an amount of light incidence required by one single lens unit of the present invention is less than that of the conventional image sensor. Therefore, the invention utilizes thinned lens units to promote the signal-to-noise ratio and improve the resolution and quality of the color image without significantly increasing the volume of the lens unit as the conventional image sensing module. Consequently, the image sensing module in the invention provides slim structures to be applied to all thinned devices.

On the other hand, the single lens unit in the invention optimizes the part of color light such that the complexity of each lens unit can be reduced. For example, each lens unit uses less, thinner, or cheaper lens to reduce the dispersion. Alternatively, each lens unit uses less, thinner, or cheaper lens without reducing the dispersion to further minimize the thickness of the lens unit. In this way, each lens unit can be widely applied to thinned devices. For instance, when the invention is applied to the smart phone, the surface of each lens unit and the surface of the casing of the smart phone are at the same plane or approximately at the same plane.

### BRIEF DESCRIPTION OF THE DRAWINGS

FIG. 1 is a plane schematic diagram of the image sensing module of the invention applied to a smart phone;

FIG. 2 is a block diagram of the image sensing module in a first embodiment of the invention;

FIG. 3A is an assembly schematic diagram of the first image sensor and the red-light filter unit in the first embodiment of the image sensor in the invention;

FIG. 3B is an assembly schematic diagram of the second image sensor and the green-light filter unit in the first embodiment of the image sensor in the invention;

FIG. 3C is an exploded schematic diagram of the third image sensor and the blue-light filter unit in the first embodiment of the image sensor in the invention;

FIG. 4 is a schematic diagram of the lens unit, the image sensor and the filter unit formed by multiple lenses in the invention;

FIG. 5A is a block diagram of three motors, three lens units, a motor controller and a processor in the focusing driving unit of the invention;

FIG. 5B is a block diagram of a motor, three lens units, a motor controller and a processor in the focusing driving unit of the invention;

FIG. 6 is a schematic diagram of the image sensing module in a second embodiment of the invention;

FIG. 7 is a schematic diagram of the image sensing module in a third embodiment of the invention;

FIG. 8 is a schematic diagram of the image sensing module in a fourth embodiment of the invention;

FIG. 9 is a first schematic diagram of the filter unit disposed between the second lens unit and the second image sensor for the image sensing module in the fifth embodiment of the invention;

FIG. 10 is a second schematic diagram of the filter unit disposed between the second lens unit and the second image sensor for the image sensing module in the fifth embodiment of the invention;

FIG. 11 is a schematic diagram of the image sensing module in the sixth embodiment of the invention;

FIG. 12 is a schematic diagram of the filter film of the first composite filter unit arranged in a matrix in the image sensing module in the sixth embodiment of the invention;

FIG. 13 is a schematic diagram of the filter film of the second composite filter unit arranged in a matrix in the image sensing module in the sixth embodiment of the invention;

FIG. 14 is a schematic diagram of the image sensing module in the seventh embodiment of the invention;

FIG. 15 is a schematic diagram of the filter film of the composite filter unit arranged in a matrix in the image sensing module in the seventh embodiment of the invention;

FIG. 16 is a schematic diagram of the monochrome filter film of the composite filter unit arranged in a matrix in the image sensing module in the seventh embodiment of the invention;

FIG. 17 is a schematic diagram of the image sensing module in the eighth embodiment of the invention;

FIG. 18 is a schematic diagram of the image sensing module in the ninth embodiment of the invention;

FIG. 19 is a schematic diagram of the image sensing module in the tenth embodiment of the invention;

FIG. 20 is an exploded schematic diagram of the conventional image sensing module.

### DETAILED DESCRIPTION OF THE INVENTION

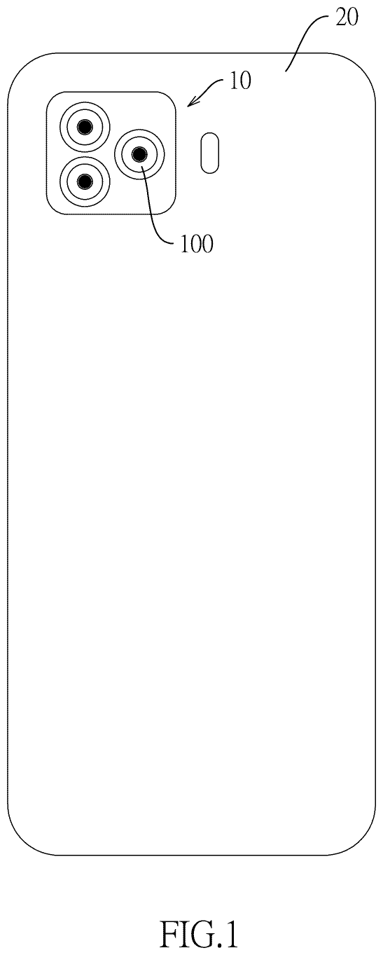

The invention discloses a thinable image sensing module, that is, a camera module. The thinable image sensing module can be installed in an electronic device, particularly in the electronic device featuring a thinned design. The image sensing module of the invention is such as a mobile camera of a smart phone, a tablet computer, or a laptop computer, but not limited thereto. For example, in FIG. 1, the image sensing module 10 of the invention is installed in a smart phone 20.

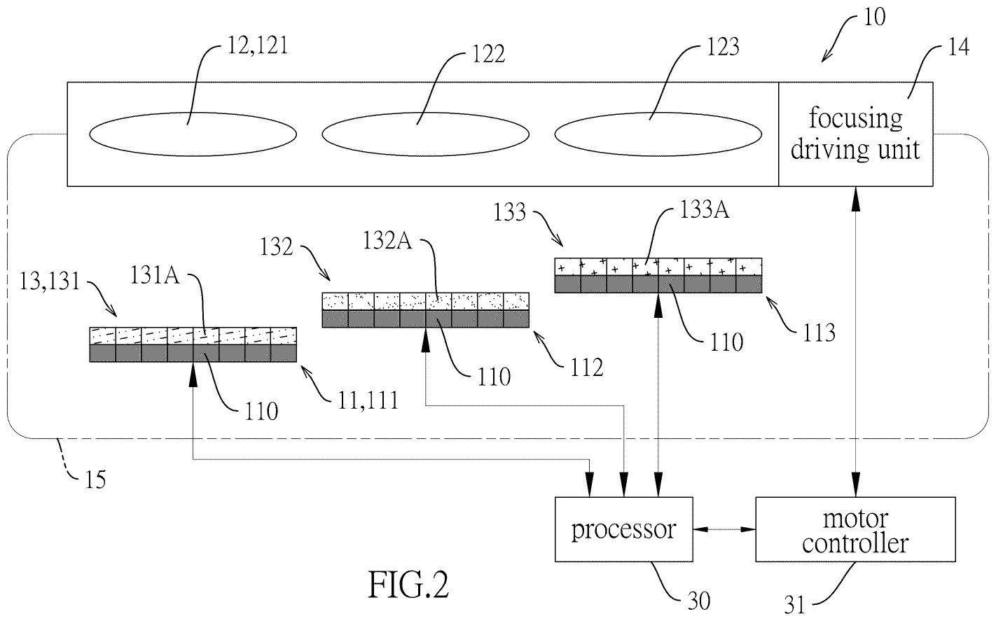

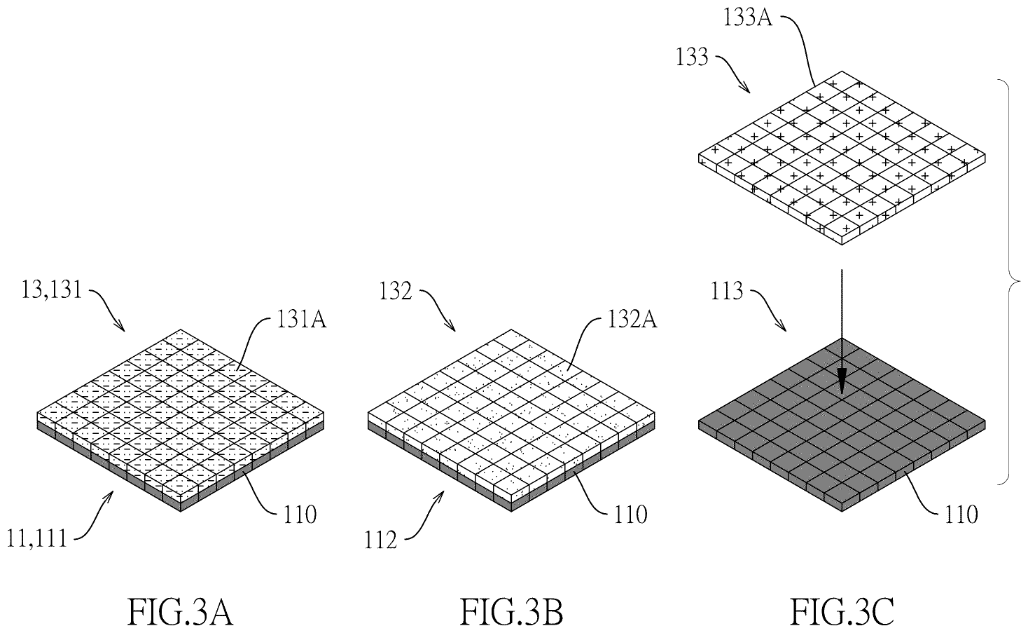

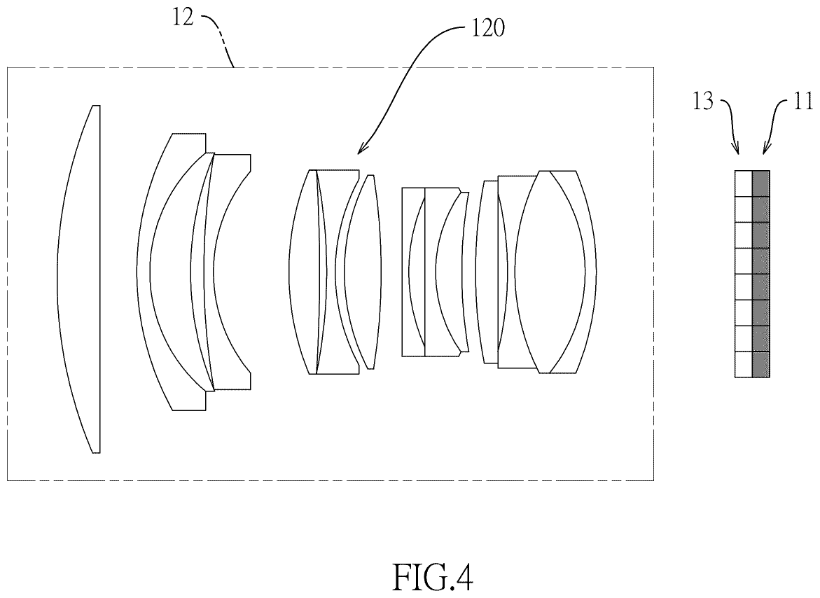

Please refer to FIG. 2, FIG. 3A to FIG. 3C. The image sensing module 10 of the invention comprises at least two image sensors 11, at least two lens units 12, and at least two filter units 13. In another embodiment, the image sensing module 10 further comprises a focusing driving unit 14. The image sensors 11, the lens units 12, the filter units 13, and the focusing driving unit 14 are disposed in a frame 15.

The at least two image sensors 11 are disposed separately. FIG. 2 illustrates three image sensors 11 as an example. Therefore, FIG. 1 illustrates three cameras 100 corresponding to the three image sensors 11. In another embodiment, the amount of the image sensors 11 is two. The details are described as below. Each image sensor 11 has a light-incident surface for receiving light. Each image sensor 11 comprises a plurality of image elements 110. The plurality of image elements 110 are arranged in a matrix. Each of the image elements 110 is such as a Complementary Metal-Oxide-Semiconductor (CMOS).

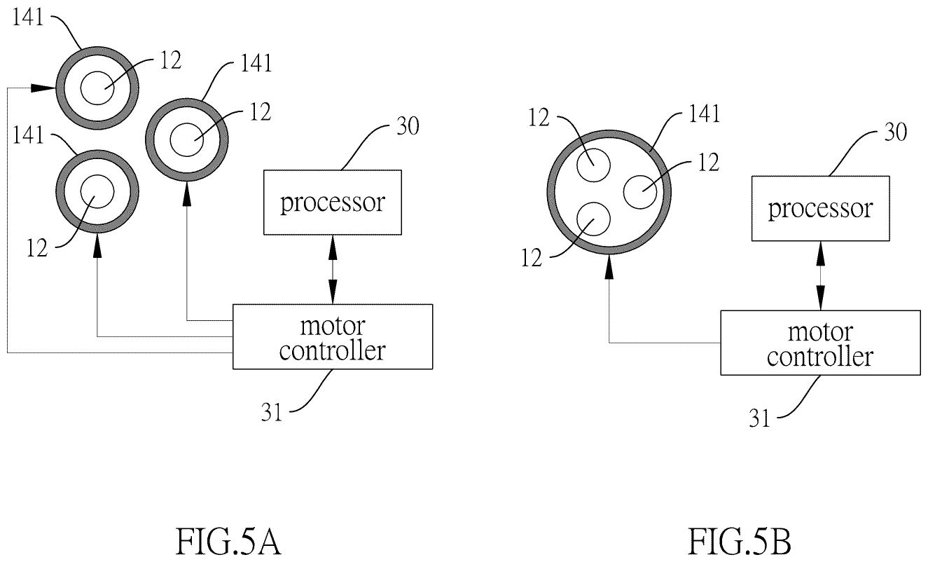

The at least two lens units 12 are respectively disposed at the outer side of the light-incident surface of the at least two image sensors 11. Referring to FIG. 4, it is comprehensible that each lens unit 12 is substantially composed of multiple lenses 120 to achieve the focus function. In an embodiment of the invention, a lens unit 12 corresponds to an image sensor 11, in a one-to-one correspondence. For example, if the amount of the image sensors 11 is three, the amount of the lens units 12 is also three. It should be noted that since the image sensors 11, the lens unit 12, and the filter unit 13 are disposed in the frame 15, the relative position and the relative distance of each image sensor 11, each lens unit 12, and each filter unit 13 can be determined by the structure of the frame 15.

The at least two filter units 13 are respectively disposed between the at least two image sensors 11 and the at least two lens units 12. The filtering characteristics of the at least two filter units 13 are distinct from each other. The filtering characteristic represents that the wavelengths of the filtered lights are various from each other. Hence, the at least two image sensors 11 are capable of sensing lights of all colors via the at least two filter units 13, i.e. the color range that can be perceived by the human eyes. For the same reason, a filter unit 13 corresponds to an image sensor 11, in a one-to-one correspondence. For example, if the amount of the image sensors 11 is three, the amount of the filter units 13 is also three.

By the aforementioned structures, after the external light penetrates the lens units 12 and the filter units 13, the external light is sensed by the image element 110 of the image sensors 11. The image element 110 of the image sensors 11 is electrically connected to a processor 30. The processor 30 calculates, merges, and generates a color image according to the output signal of the image element 110 of the image sensors 11. The processor 30 comprises a central processing unit (CPU) or a graphics processing unit (GPU) of the smart phone 20. It needs to be noted and comprehended that the figures in the invention merely illustrate the image element 110, such as the image element 110 in FIG. 3A to FIG. 3C. Taking the image element 110 in FIG. 3A to FIG. 3C as an example: the image element 110 is arranged in an 8×8 matrix. In fact, the amount of the row and column of the matrix formed by the image elements 110 can exceed thousands.

The lens unit 12 focuses light to form images on the image element 110 by the focusing driving unit 14. The focusing driving unit 14 is coupled to the at least two lens units 12 to synchronously drive a part of the lens 120 for focusing light on the at least two lens units 12. The focusing driving unit 14 is electrically connected to the processor 30. The processor 30 generates a driving signal to drive the focusing driving unit 14 and to further synchronously drive the part of the lens 120 for focusing light on the at least two lens units 12 to vary angles or displacements. Therefore, the focus can be adjusted and focused. The processor 30 is electrically connected to the focusing driving unit 14 via a motor controller 31. In an embodiment, the focusing driving unit 14 comprises at least two motors. Each motor is selected from a focus motor, a zoom motor, or a camera shock-proof motor. At least two motors are respectively coupled to the at least two lens units 12. Please refer to FIG. 5A: as the aforementioned three lens units 12, the focusing driving unit 14 comprises the three motors 141 such that each lens unit 12 is arranged in a respective one of the motors 141. One motor 141 corresponds to couple one lens unit 12, that is, the motor 141 and the lens unit 12 are a one-to-one structure. Please refer to FIG. 5B: in another embodiment, the focusing driving unit 14 comprises a single motor 141. The lens units 12 are arranged in the motor 141 and coupled to the motor 141 together. In other words, when the motor 141 operates, the motor 141 synchronously drives the part of the lens 120 for focusing light on the lens units 12.

It should be noted that the driving principles of the focusing driving unit 14 and the lens units 12 are not emphasis of the invention; therefore, the details are omitted. For instance, FIG. 5A and FIG. 5B illustrate the motor 141, which is a voice coil motor (VCM). The voice coil motor collaboratively utilizes the coil, the magnet, and the elastic piece to generate magnetic force to synchronously adjust the angle and the displacement of the lens in the lens units 12. Accordingly, the focus can be synchronously adjusted and focused. The features of the invention are described as in the below embodiments. In the structure, each image sensor 11 and each lens unit 12 have been arranged at an appropriate relative distance. The part of the lens 120 for focusing light in the lens units 12 can be synchronously driven and moved and can respectively correspond to focus on the image sensors 11. Consequently, each motor 141 in the invention is not individually and asynchronously driven. For the lens units 12 in the invention, the plurality of the motors 141 in FIG. 5A or the single motor 141 in FIG. 5B in the invention is logically equivalent to a motor.

The embodiments of the image sensing module in the invention are illustrated with the below figures.

### The First Embodiment

Referring to FIG. 2 and FIG. 3A to FIG. 3C, the image sensors 11 comprise a first image sensor 111, a second image sensor 112, and a third image sensor 113. The lens units 12 comprise a first lens unit 121, a second lens unit 122, and a third lens unit 123. According to the demand and the optical feature of the optical material, the filter units 13 comprise a red-light filter unit 131, a green-light filter unit 132, and a blue-light filter unit 133. In another embodiment (not shown in the figure), the filter units 13 comprise a red-light filter unit, a yellow-light filter unit, and a blue-light filter unit. In the embodiment, the embodiment takes the combination of the red-light filter unit 131, the green-light filter unit 132, and the blue-light filter unit 133 as an example. The wave length of light that can be filtered by each filter unit 13 corresponds to the range of color light perceived by human eyes. For instance, the light of a wavelength between 625 and 740 nm can penetrate the red-light filter unit 131. The light of a wavelength between 500 and 565 nm can penetrate the green-light filter unit 132. The light of a wavelength between 480 and 500 nm can penetrate the blue-light filter unit 133. The light of a wavelength between 565 and 590 nm can penetrate the yellow-light filter unit. As mentioned above, the wavelengths of light capable of penetrating the red-light filter unit, the green-light filter unit, the blue-light filter unit, and the yellow-light filter unit are approximate values.

In the first embodiment, the red-light filter unit 131 comprises a plurality of red-light filter films 131A, respectively disposed on the image elements 110 of the first image sensor 111. Hence, the red-light filter films 131A are arranged in a matrix. For the same reason, the plurality of green-light filter films 132A of the green-light filter unit 132 are respectively disposed on the image elements 110 of the second image sensor 112 and are arranged in a matrix. The plurality of blue-light filter films 133A of the blue-light filter unit 133 are respectively disposed on the image elements 110 of the third image sensor 113 and are arranged in a matrix.

As for the refractive index, the refractive index of the red-light filter film 131A is lower than the refractive index of the green-light filter film 132A. The refractive index of the green-light filter film 132A is lower than the refractive index of the blue-light filter film 133A. Therefore, the relative distance between the first image sensor 111 and the first lens unit 121 is higher than the relative distance between the second image sensor 112 and the second lens unit 122. Furthermore, the relative distance between the second image sensor 112 and the second lens unit 122 is larger than the relative distance between the third image sensor 113 and the third lens unit 123.

Corresponding to the aforementioned relative distance, in the first embodiment as shown in FIG. 2, the first image sensor 111, the second image sensor 112, and the third image sensor 113 are disposed at different planes. The curvature of the first lens unit 121, the curvature of the second lens unit 122, and the curvature of the third lens unit 123 are the same. The first lens unit 121, the second lens unit 122, and the third lens unit 123 are disposed at the same plane. In the first embodiment as shown in FIG. 2, the lens units 12 utilize the same focusing driving unit 14 to reduce interference resulting from the distinct focus distances, such as the magnetic interference.

### The Second Embodiment

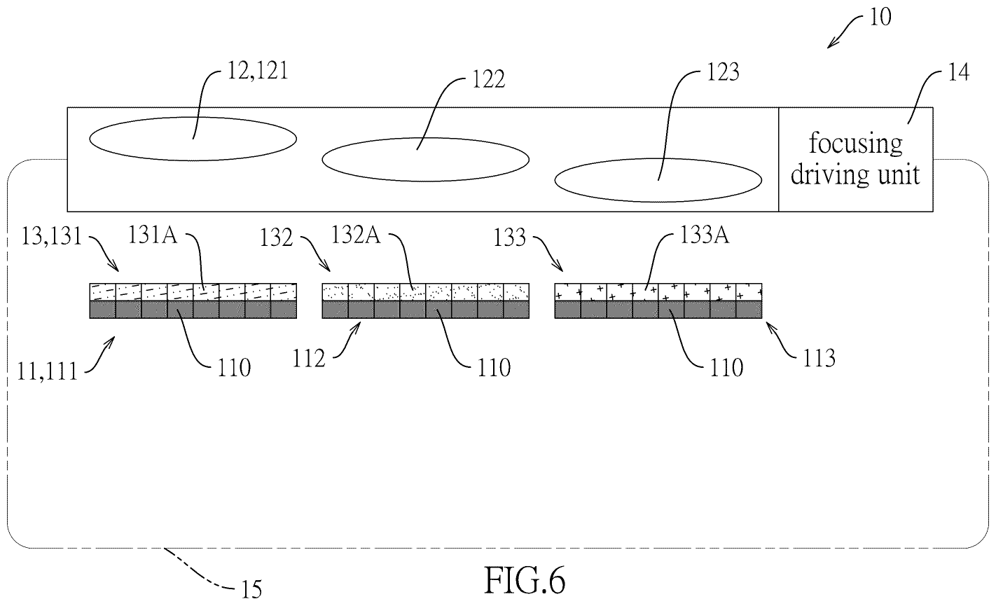

Please refer to the second embodiment in FIG. 6: the difference from the first embodiment is that the first image sensor 111, the second image sensor 112, and the third image sensor 113 are at the same plane in the second embodiment. Moreover, the first lens unit 121, the second lens unit 122, and the third lens unit 123 are disposed at different planes. In the second embodiment as shown in FIG. 6, the lens units 12 utilize the same focusing driving unit 14 to reduce the interference resulting from the distinct focus distances, such as the magnetic interference.

### The Third Embodiment

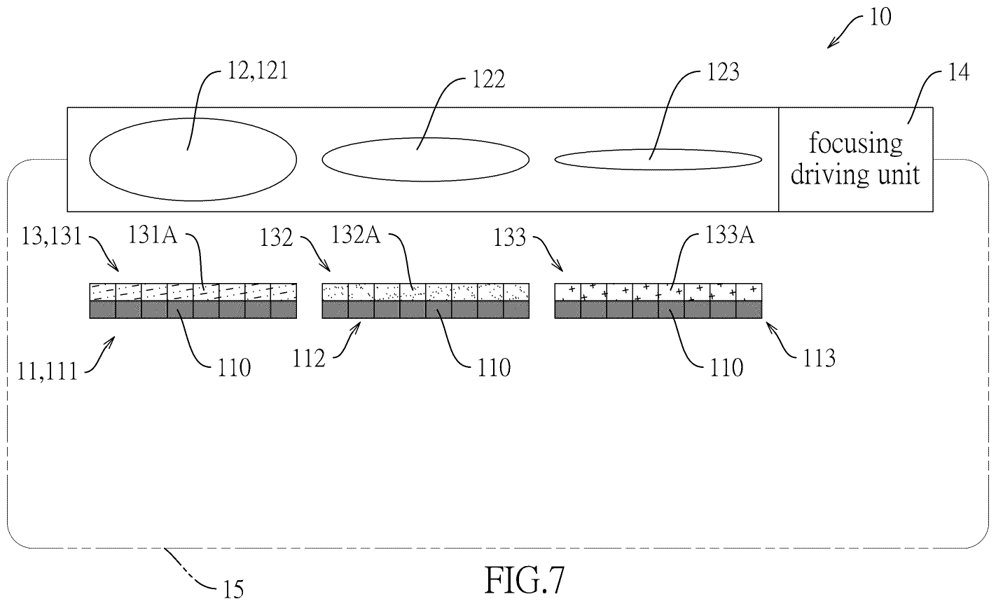

Please refer to the third embodiment in FIG. 7: the difference between the third embodiment and the first embodiment is that in the third embodiment, the first image sensor 111, the second image sensor 112, and the third image sensor 113 are at the same plane and the curvatures of each lens unit 12 are distinct. The curvature of the first lens unit 121 is more than the curvature of the second lens unit 122. The curvature of the second lens unit 122 is more than the curvature of the third lens unit 123. Please refer to FIG. 4: it is comprehensible that, each lens unit 12 is composed of multiple lens. Hence, each lens unit 12 is regarded as corresponding to an equivalent lens in the multiple lens. As mentioned above, the “curvature” of each lens unit 12 represents an “equivalent curvature” of the equivalent lens and so on in other embodiments of the invention. Consequently, in the embodiment, the red-light filter unit 131, the green-light filter unit 132, and the blue-light filter unit 133 generate an equal focus via the various curvatures of the first lens unit 121, the second lens unit 122, and the third lens unit 123 such that lights of these three colors can be accurately imaged on the first image sensor 111, the second image sensor 112, and the third image sensor 113 when the first lens unit 121, the second lens unit 122, and the third lens unit 123 are coupled together. In the third embodiment as shown in FIG. 7, the lens units 12 utilize the same focusing driving unit 14 to reduce the interference resulting from the distinct focus distances, such as the magnetic interference.

### The Fourth Embodiment

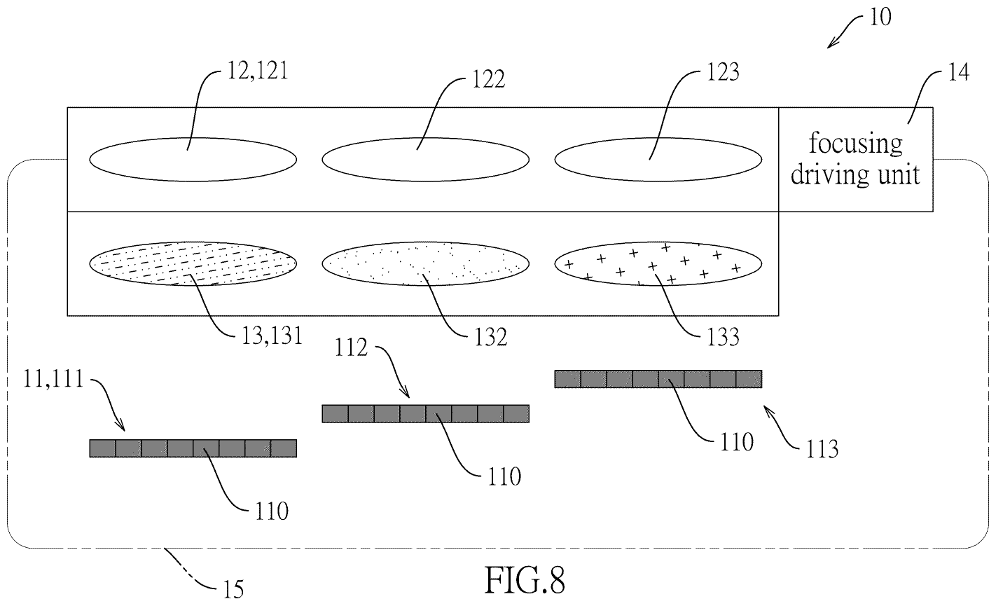

Please refer to the fourth embodiment in FIG. 8: the difference between the first embodiment and the fourth embodiment is that each filter unit 13 is separated from each image sensor 11 in the fourth embodiment. The red-light filter unit 131 is disposed on a red-light filter lens of the first image sensor 111. The green-light filter unit 132 is disposed on a green-light filter lens of the second image sensor 11. The blue-light filter unit 133 is disposed on a blue-light filter lens of the third image sensor 113. The red-light filter lens, the green-light filter lens, and the blue-light filter lens are disposed in the frame 15.

### The Fifth Embodiment

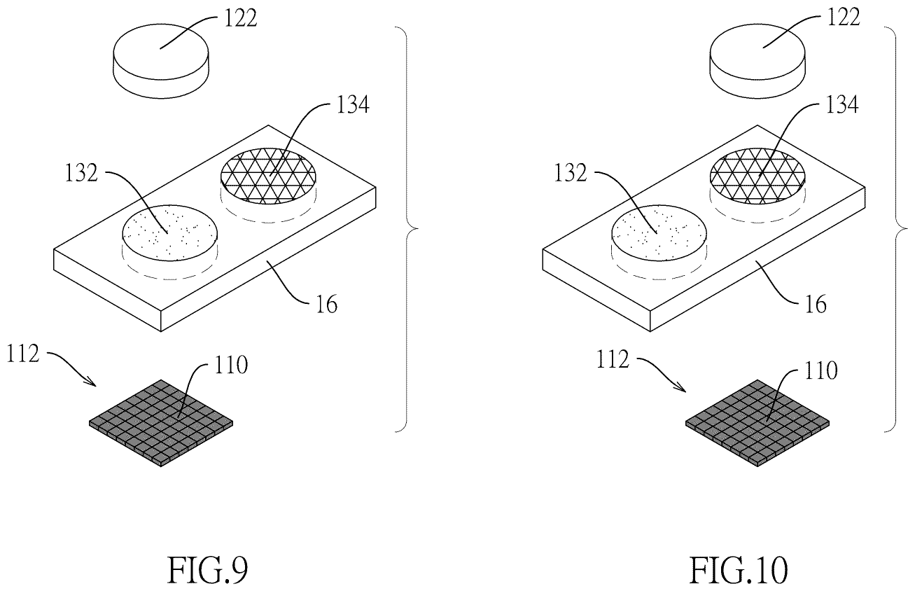

Please refer to FIG. 9: the difference between the fifth embodiment and the fourth embodiment is that the fifth embodiment further comprises a filter unit of another color, such as a yellow-light filter unit 134 and a carrier 16. The yellow-light filter unit 134 is a yellow filter lens. The yellow-light filter unit 134 and the green-light filter unit 132 are disposed in the carrier 16 along a straight line. The top surface and the bottom surface of the yellow-light filter unit 134 and the green-light filter unit 132 are exposed outside the carrier 16. The carrier 16 is connected to an actuator (not shown in the figure). The actuator comprises a linear motor or an ultrasound motor. The actuator enables the carrier 16 to move back and forth along a straight line. The straight line that the yellow-light filter unit 134 and the green-light filter unit 132 moves along corresponds to the straight line that the carrier 16 moves along. The actuator is electrically connected to the processor 30 and is controlled by the processor 30. In another embodiment, the carrier 16 can be switched manually. In addition, the processor 30 can detect the position of the carrier 16 via a detection element, such as a micro-switch.

Therefore, a first state as shown in FIG. 9 illustrates that the green-light filter unit 132 is disposed between the second lens unit 122 and the second image sensor 112. When the actuator drives the carrier 16 to move, the first state is changed to a second state as shown in FIG. 10. Hence, the yellow-light filter unit 134 is disposed between the second lens unit 122 and the second image sensor 112. The processor 30 drives the actuator to switch between the first state and the second state to adapt to various scenes.

For instance, in the first state, the image elements 110 of the first image sensor 111, the second image sensor 112, and the third image sensor 113 receive red light, green light, and blue light. In general, the first state is applied in a scene having sufficient light, such as daytime. That is, the daytime can enhance the color resolution. In the second state, the image elements 110 of the first image sensor 111, the second image sensor 112, and the third image sensor 113 receive red light, yellow light, and blue light. In general, the second state is applied in a dusky scene, such as night. That is, the night can obtain better brightness information. Moreover, for adapting to various scenes, the filtering characteristic (color tone) of the green-light filter unit 132 is dark green with a high shading rate, light green with a low shading rate, or other green tone with a shading rate between the high shading rate and the low shading rate, but is not limited thereto. For the same reason, the filtering characteristic of the yellow-light filter unit 134 is dark yellow with a high shading rate, light yellow with a low shading rate, or other yellow tone with a shading rate between the high shading rate and the low shading rate, but is not limited thereto.

### The Sixth Embodiment

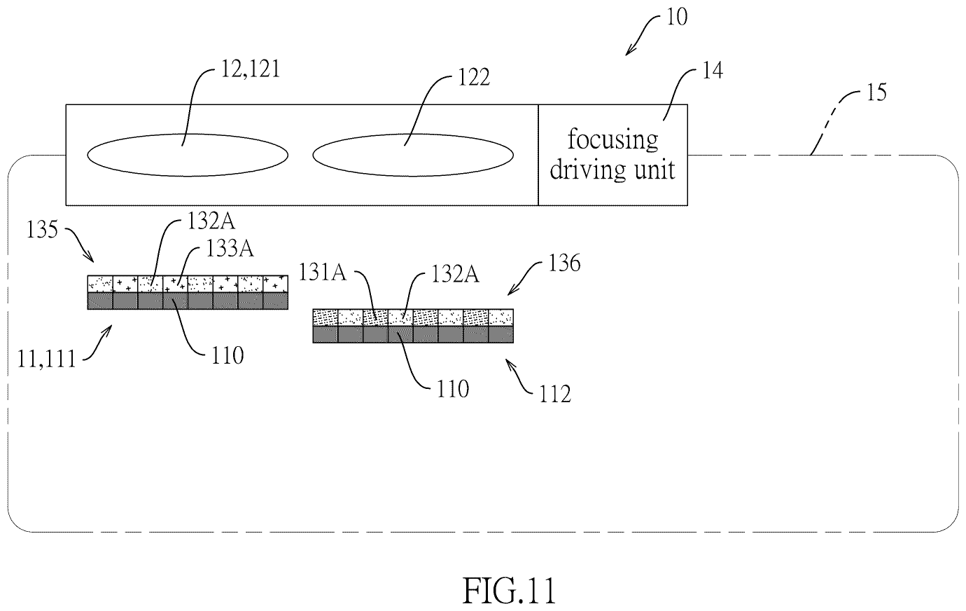

Please refer to FIG. 11 to FIG. 13: the at least two image sensors 11 are a first image sensor 111 and a second image sensor 112. The at least two lens units 12 are a first lens unit 121 and a second lens unit 122. The filter units 13 are a first composite filter unit 135 and a second composite filter unit 136. The first composite filter unit 135 comprises the filter films of various colors. In the embodiment, the first composite filter unit 135 comprises the filter films of two colors. The second composite filter unit 136 comprises the filter films of various colors. In the embodiment, the second composite filter unit 136 comprises the filter films of two colors.

The colors of light sensed by first image sensor 111 and the second image sensor 112 via the first composite filter unit 135 and the second composite filter unit 136 are equivalent to the color range that can be perceived by the human eyes. In the embodiment, the colors of the filter films of the first composite filter unit 135 and the filter films of the second composite filter unit 136 are not exactly identical. The filter films of the first composite filter unit 135 and the filter films of the second composite filter unit 136 have a same color. The first composite filter unit 135 has the filter films of more than one color and said more than one color of the filter films is entirely different from all colors of the filter films of the second composite filter unit 136. In another embodiment, the filter films of the first composite filter unit 135 and the filter films of the second composite filter unit 136 have completely distinct colors.

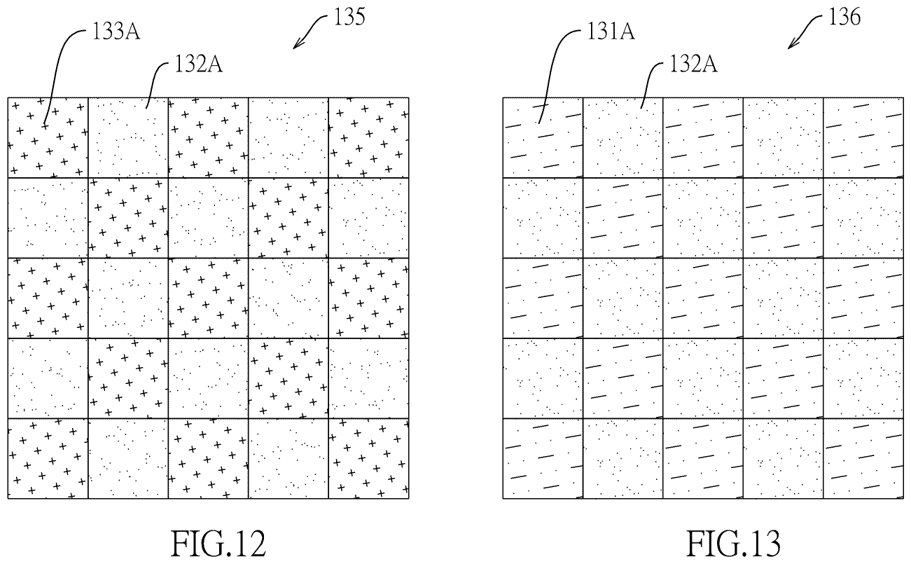

For example, when the filter film of the first composite filter unit 135 and the filter film of the second composite filter unit 136 have a same color, the filter film of the first composite filter unit 135 and the filter film of the second composite filter unit 136 are a green-light filter film 132A. The first composite filter unit 135 comprises a plurality of green-light filter films 132A and a plurality of blue-light filter films 133A. The green-light filter films 132A and the blue-light filter films 133A are respectively disposed on the image element 110 of the first image sensor 111. As shown in FIG. 12, the green-light filter films 132A and the blue-light filter films 133A are alternately arranged in row and column. The second composite filter unit 136 comprises a plurality of green-light filter films 132A and a plurality of red-light filter films 131A. The green-light filter films 132A and the red-light filter films 131A are respectively disposed on the image element 110 of the second image sensor 112. As shown in FIG. 13, the green-light filter films 132A and the red-light filter films 131A are alternately arranged in row and column. The color of the blue-light filter film 133A in the first composite filter unit 135 is different from the colors of all filter films, the green-light filter film 132A and the red-light filter film 131A, in the second composite filter unit 136. In an embodiment, the order of the red-light filter film 131A and the order of the green-light filter film 132A can be exchanged in FIG. 13. After exchanged, the green-light filter film 132A of the first composite filter unit 135 and the green-light filter film 132A of the second composite filter unit 136 occupy all pixel grids. If the position of the green-light filter film 132A in the first composite filter unit 135 and the position of the green-light filter film 132A in the second composite filter unit 136 are not exchanged, that is, corresponding to the pattern in FIG. 12 and FIG. 13, the complexity of the final image can be diminished.

As for the refractive index, the equivalent refractive index of the green-light filter film 132A and the blue-light filter film 133A is larger than the equivalent refractive index of the green-light filter film 132A and the red-light filter film 131A. Hence, the relative distance between the first image sensor 111 and the first lens unit 121 is less than the relative distance between the second image sensor 112 and the second lens unit 122. For corresponding to various lights with distinct refractive indexes, the embodiments utilize the patterns as shown in FIG. 2, FIG. 6, and FIG. 7. For example, as shown in FIG. 11, the configuration in the sixth embodiment is the same as the configuration in FIG. 2 such that the first image sensor 111 and the second image sensor 112 in FIG. 11 are at different planes. Furthermore, the curvature of the first lens unit 121 and the curvature of the second lens unit 122 are the same. The first lens unit 121 and the second lens unit 122 are disposed at the same plane.

On the other hand, since both the first composite filter unit 135 and the second composite filter unit 136 have the green-light filter film 132A, the color of light sensed by the first image sensor 111 and the second image sensor 112 has an intersection, that is, green light. In this way, when the processor 30 merges the images according to the output signal of the first image sensor 111 and the second image sensor 112, the pixels of the same color (the embodiment takes green as an example) can be a reference point such that the processor 30 easily and accurately merges the images.

On the other hand, for promoting the performance in a high brightness environment, the color of one of the filter films in one of the composite filter units can be reinforced, that is, the transmission rate of the filter film can be abated. For instance, gray can be disposed on the green-light filter film 132A of the first composite filter unit 135 to diminish the transmission rate. In this way, during photographing, the first composite filter unit 135 has a better performance in the high brightness environment. In contrast, the second composite filter unit 136 has a better performance in the low brightness environment.

In another embodiment, when the filter films of the first filter unit 135 and the filter films of the second composite filter unit 136 have distinct colors, the first composite filter unit 135 comprises a plurality of red-light filter films and a plurality of yellow filter films and the second composite filter unit 136 comprises a plurality of green-light filter films and a plurality of blue-light filter films. The arrangements are described above and the details are omitted hereinafter.

### The Seventh Embodiment

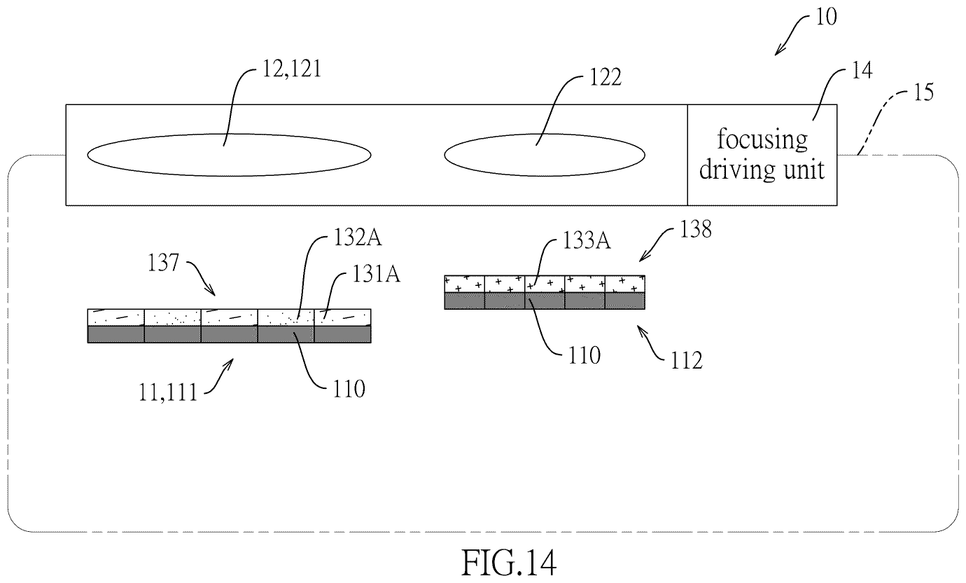

Please refer to FIG. 14 to FIG. 16: the image sensors 11 are a first image sensor 111 and a second image sensor 112. The lens units 12 are a first lens unit 121 and a second lens unit 122. The filter units 13 are a composite filter unit 137 and a monochrome filter unit 138. The composite filter unit 137 comprises the filter films of various colors. In the embodiment, the composite filter unit 137 comprises the filter films of two colors. The monochrome filter unit 138 has the filter films of one color. The color of the filter films in the composite filter unit 137 is different from the color of the filter films in the monochrome filter unit 138. The first image sensor 111 and the second image sensor 112 respectively correspond to the color of light sensed via the composite filter unit 137 and the monochrome filter unit 138 to the color that human eyes can perceive.

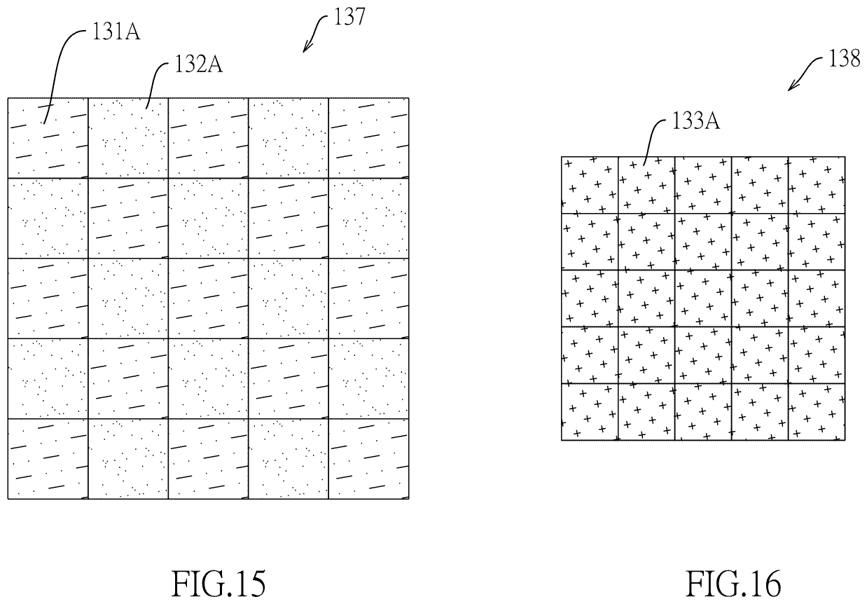

It can be apprehensive that the narrower the spectrum sensed by each image sensor 11 is, the slighter the dispersion is. In other words, the dispersion for continuous color light is minor than the dispersion for discontinuous color light in the spectrum. Therefore, in the best mode, the colors of the two filter films in the composite filter unit 137 are the colors of continuous color light in the spectrum, such as the colors selected from the combinations of the red-light filter film and the green-light filter film or the green-light filter film and the blue-light filter film. For instance, the composite filter unit 137 comprises a plurality of red-light filter films 131A and a plurality of green-light filter films 132A. The red-light filter films 131A and the green-light filter films 132A are respectively disposed on the image element 110 of the first image sensor 111. As shown in FIG. 15, the red-light filter films 131A and the green-light filter films 132A are alternated in row and column. As shown in FIG. 16, the monochrome filter unit 138 comprises a plurality of blue-light filter films 133A. The blue-light filter films 133A are respectively disposed on the image element 110 of the second image sensor 112.

For the refractive index, the equivalent refractive index combined by the green-light filter film 132A and red-light filter film 131A is lower than the refractive index of the blue-light filter film 133A. Consequently, the relative distance between the first image sensor 111 and the first lens unit 121 is more than the relative distance between the second image sensor 112 and the second lens unit 122. In the seventh embodiment as shown in FIG. 14, the first image sensor 111 and the second image sensor 112 are disposed at different planes. The curvature of the first lens unit 121 is the same as the curvature of the second lens unit 122. The first lens unit 121 and the second lens unit 122 are disposed at the same plane.

Since the composite filter unit 137 utilizes the configuration of the filter film of continuous color light in the spectrum, the requirement of the lens for the dispersion is lower and the design and structure of the first lens unit 121 can be simplified. On the other hand, since the second image sensor 112 senses a single color light via the monochrome filter unit 138, the second image sensor 112 can implement an all pixel phase detection method. The all pixel phase detection method can be referred to the 2×2 on-chip lens (OCL) technology or the Octa PD technology of Sony Corporation. For the processor 30, since the output signals received by the second image sensor 112 comprise the same colors, filtered via the blue-light filter film 133A, all pixels and neighbor pixels thereof can form the phase focus and the focus accuracy can be improved. As shown in FIG. 14, the structure of the second image sensor 112 can be simplified. For a prerequisite that each color has the same amount of light, the area of the image element 110 in the second image sensor 112 can be less than the area of the image element 110 in the first image sensor 111. That is, the amount of light of each pixel in the second image sensor 112 corresponds to the amount of light of the sensitive element in the sensed image element 110. In contrast, the area and volume of the second lens unit 122 can be less than the area and volume of the first lens unit 121 to save space.

### The Eighth Embodiment

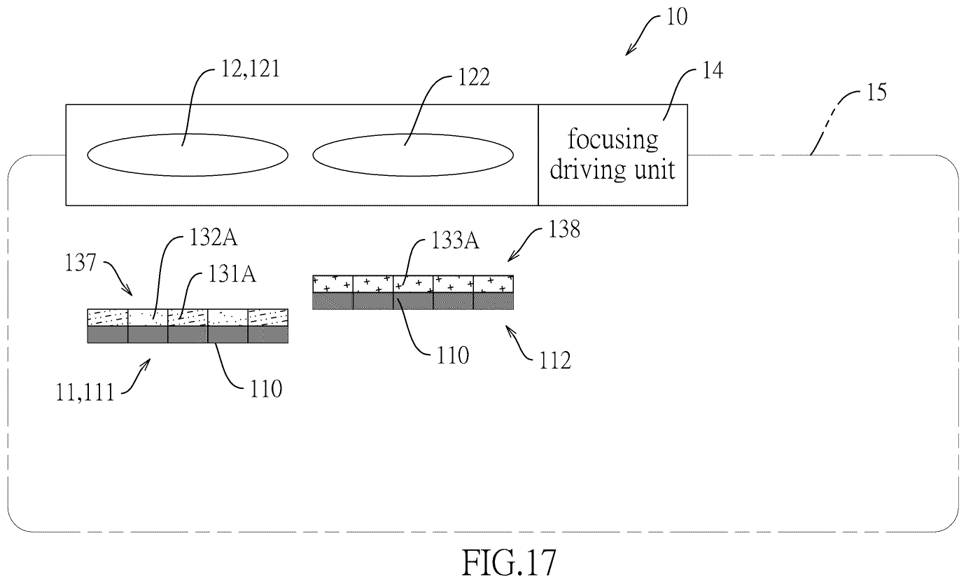

Contrary to the seventh embodiment in FIG. 14, in the eighth embodiment in FIG. 17, the area of the image element 110 in the second image sensor 112 is equal to the area of the image element 110 in the first image sensor 111. In the meanwhile, contrary to the first image sensor 111 and the second image sensor 112, the color light sensed by the first image sensor 111 comprises two colors and the color light sensed by the second image sensor 112 comprises a single color. The area of the image element 110 in the second image sensor 112 is more than the area of the image element 110 in the second image sensor 112 in the seventh embodiment. Furthermore, the amount of light of the image element 110 in the second image sensor 112 is more than the amount of light of the image element 110 in the second image sensor 112 in the seventh embodiment. Therefore, when the amount of the image element 110 in the first image sensor is the same as the amount of image element 110 in the second image sensor 112, the resolution for the color light of the second image sensor 112 is more than the resolution for the color light of the first image sensor 111. In other words, the resolution for the color light of the second image sensor 112 is twice as high as the resolution for the color light of the first image sensor 111. The processor can hence obtain the better image performance for composing images in distinct shooting situations.

### The Ninth Embodiment

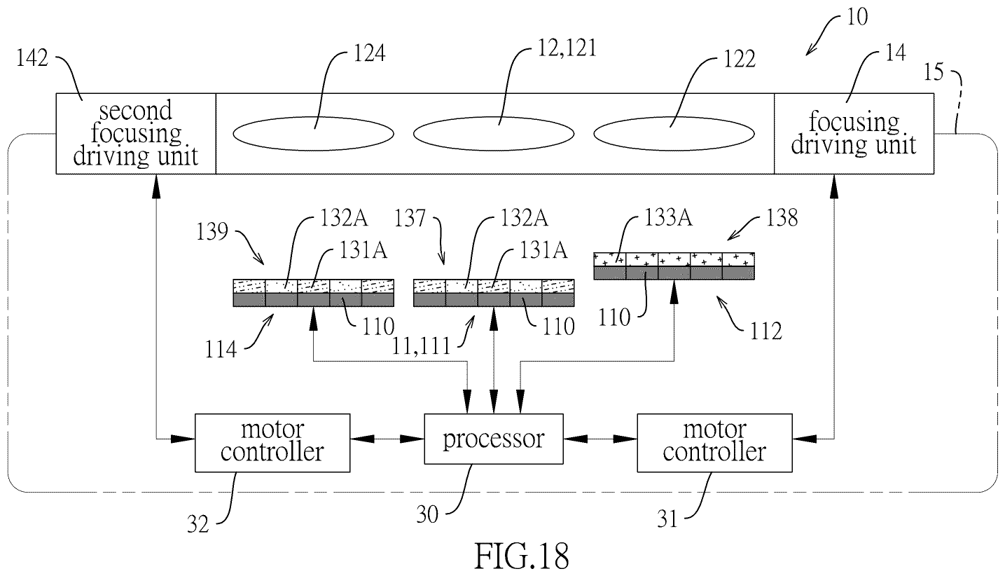

Contrary to the eighth embodiment in FIG. 17, the ninth embodiment as shown in FIG. 18 further comprises a second composite filter unit 139, a third image sensor 114, and a third lens unit 124. In another embodiment, the ninth embodiment further comprises a second focusing driving unit 142. The focusing driving unit 14 as shown in FIG. 17 comprises a first focusing driving unit. The structure and the function of the second composite filter unit 139 are equivalent to the structure and the function of the composite filter unit 137. The structure and the function of the third image sensor 114 are equivalent to the structure and the function of the first image sensor 111. The third image sensor 114 and the first image sensor 111 are at the same plane or at distinct planes such that the third lens unit 124 and the second lens unit 122 have a similar focusing progress. The first lens unit 121 comprises a wide-angle lens unit, applied to a wide-angle shooting situation and described as below. The third lens unit 124 comprises a long focus lens unit, applied to a long focus shooting situation and described as below. The focus of the first lens unit 121 is the same as the focus of the second lens unit 122, such as the focus equal to 28 mm in the whole focus distance. The second focusing driving unit 142 comprises a voice coil motor, coupled to the third lens unit 124. The processor 30 is electrically connected to the second focusing driving unit 142 via a motor controller 32 to drive the focus lens group in the third lens unit 124 to focus.

In the wide-angle shooting situation, the first lens unit 121 and the second lens unit 122 utilize the same focusing driving unit 14 as mentioned above. In the long focus shooting situation, the focusing driving unit 14, that is, the first focusing driving unit, and the second focusing driving unit 142 are synchronously controlled by the processor 30. In other words, the focusing driving unit 14, that is, the first focusing driving unit and the second focusing driving unit 142 are logically equivalent to a motor. In the long focus shooting situation, the focusing driving unit 14 drives the second lens unit 122. The second focusing driving unit 142 drives the third lens unit 124. The first lens unit 121 is disposed between the second lens unit 122 and the third lens unit 124. The first lens unit 121 fails to be driven in the long focus shooting situation. Hence, the first lens unit 121 is regarded as an isolated space free from the magnetic field interference. For example, the focusing driving unit 14 is divided to two smaller focus motors. The focusing driving unit 14 is able to simultaneously drive the second lens unit 122 and the first lens unit 121. Alternatively, the focusing driving unit 14 is able to individually drive the second lens unit 122 and the first lens unit 121.

When the processor 30 performs the function in the long focus shooting situation, the processor 30 defines the images as a first image and a second image according to the images generated by the output signal of the second image sensor 112 and the third image sensor 114. Since the color light resolution of the second image sensor 112 is higher than that of the third image sensor 114, when the processor 30 calculates and merge the first image and the second image, the processor 30 calculates and combines a part of middle pixels in the first image and the second image to generate a long focus image with real and high resolutions.

When the processor 30 performs the function in the wide-angle shooting situation, the processor 30 defines the images as a first image and a third image according to the images generated by the output signal of the second image sensor 112 and the first image sensor 111. When the processor 30 calculates and merges the first image and the third image, the processor 30 calculates and combines all pixels in the third image and the first image. In this way, each pixel calculated and combined by the processor 30 has a real red and blue information or a real green and blue information. The green information needed by red and blue information and the red information needed by green and blue information are achieved by a De-mosaicing method. For instance, the De-mosaicing method interpolates the colors of adjacent logical pixels. Since the color, green information or red information to be calculated by each logical pixel is fewer, realistic and vivid colors can be obtained.

### The Tenth Embodiment

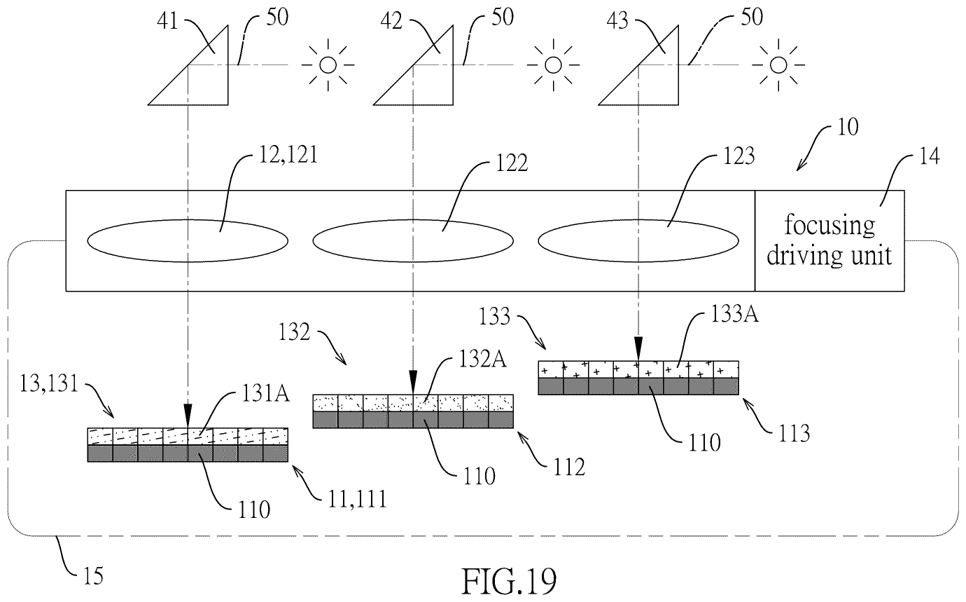

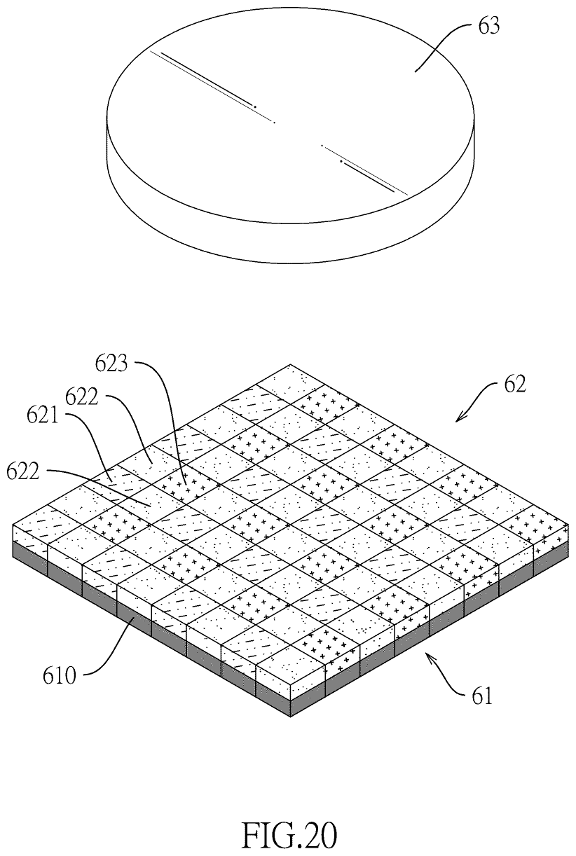

The tenth embodiment of the invention further comprises at least two beam splitters. The at least two beam splitters are installed in the frame 15 and respectively disposed at an outer side of the light-incident surface of the at least two lens units to form a periscopic image sensing module. Each beam splitter comprises a prism. For instance, the embodiment in FIG. 19 is based on the embodiment in FIG. 2. The at least two beam splitters comprise a first beam splitter 41, a second beam splitter 42, and a third beam splitter 43. The first beam splitter 41 is disposed at an outer side of the first lens unit 121. The second beam splitter 42 is disposed at an outer side the second lens unit 122. The third beam splitter 43 is disposed at an outer side the third lens unit 123. By the structure, the first beam splitter 41, the second beam splitter 42, and the third beam splitter 43 reflect natural light 50 from the external environment to the first image sensor 111, the second image sensor 112, and the third image sensor 113 via the lens units 12 and the filter units 13. Similarly, other embodiments in the invention can implement the beam splitter and the details thereof are omitted.

In summary, the image sensors 11 in the invention are capable of sensing the range of color light that normal human eyes can perceive via the filter units 13. Each image sensor 11 senses a part of color light via the filter unit 13 corresponding to each image sensor 11. When the amount of the image element 110 in the image sensor 11 is added, less amount of light incidence is needed and the relative distance between the image sensors 11 and the lens units 12 will not be significantly increased. Moreover, the lens units 12 utilize the same motor 141(as shown in the embodiment in FIG. 5B). Alternatively, multiple motors 141 and the lens units 12 are closely installed together, such as the embodiment as shown in FIG. 5A. Since the focusing principles of the lens units 12 are similar, the interference such as the magnetic interference between the driving units can be avoided such that the utility or design of the driving mechanism can be simplified. In other words, the embodiment arranges the positions of the cameras or the distances between the cameras and the image elements according to various refractive indexes of color light, the interference such as the magnetic interference between the driving units can be avoided such that the utility or design of the driving mechanism can be simplified. In addition, the invention utilizes a part of the lens unit and the image sensor with the image sensor 11 having distinct focuses, as shown in the embodiment in FIG. 18. Hence, the invention uses a slim thickness or volume to enhance the signal-to-noise ratio and improve the resolution and the quality of the color image. Ultimately, the invention provides a thinable structure.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A thinable image sensing module, comprising:
at least two image sensors, separately disposed; wherein each image sensor has a light-incident surface and comprises a plurality of image elements arranged in a matrix;
at least two lens units, respectively disposed at an outer side of the light-incident surface of the at least two image sensors; wherein each lens unit is composed of multiple lenses; and
at least two filter units, respectively disposed between the at least two image sensors and the at least two lens units; wherein filtering characteristics of the at least two filter units are distinct.

2. The thinable image sensing module as claimed in claim 1, wherein the at least two image sensors are disposed at different planes; and
wherein curvatures of the at least two lens units are the same, and the at least two lens units are disposed at the same plane.

3. The thinable image sensing module as claimed in claim 1, wherein the at least two image sensors are disposed at the same plane; and
wherein curvatures of the at least two lens units are the same, and the at least two lens units are disposed at different planes.

4. The thinable image sensing module as claimed in claim 1, wherein the at least two image sensors are disposed at the same plane; and
wherein curvatures of the at least two lens units are distinct.

5. The thinable image sensing module as claimed in claim 1, further comprising:
a focusing driving unit, coupled to the at least two lens units to synchronously drive a focus lens group in the at least two lens units.

6. The thinable image sensing module as claimed in claim 1, wherein each image sensor comprises a plurality of image elements arranged in a matrix;
wherein each filter unit comprises a plurality of filter films, and the filter films are respectively disposed on the image elements of the image sensor.

7. The thinable image sensing module as claimed in claim 1, wherein each filter unit is a filter lens disposed on each image sensor.

8. The thinable image sensing module as claimed in claim 1, wherein the at least two image sensors are three image sensors, the at least two lens units are three lens units, and the at least two filter units are a red-light filter unit, a green-light filter unit, and a blue-light filter unit.

9. The thinable image sensing module as claimed in claim 8, wherein the at least two filter units further comprises a yellow-light filter unit;
wherein the green-light filter unit and the yellow-light filter unit are disposed in a carrier.

10. The thinable image sensing module as claimed in claim 1, wherein the at least two filter units are a first composite filter unit and a second composite filter unit;
wherein the first composite filter unit and the second composite filter unit respectively comprise the filter films of various colors;
wherein the first composite filter unit and the second composite filter unit have the filter films of the same color;
wherein the first composite filter unit has more than one color of the filter films that is different from all colors of the filter films in the second composite filter unit.

11. The thinable image sensing module as claimed in claim 1, wherein the at least two filter units are a composite filter unit and a monochrome filter unit, and a color of the filter film of the composite filter unit is distinct from a color of the filter film of the monochrome filter unit.

12. The thinable image sensing module as claimed in claim 5, wherein one of the lens units coupled to the focusing driving unit is a wide-angle lens unit, and the focusing driving unit is a first focusing driving unit;
wherein the image sensing module further comprises a second focusing driving unit, the at least two lens units comprise a long focus lens unit, and the second focusing driving unit is coupled to the long focus lens unit.

13. The thinable image sensing module as claimed in claim 1, further comprises at least two beam splitters;
wherein the at least two beam splitters are respectively disposed at an outer side of the at least two lens units to form a periscopic image sensing module.
